(19) United States
(12) Patent Application Publication
(10) Pub. No.: US 2012/0241694 A1
(43) Pub. Date: Sep. 27, 2012

(54) Electronic, Especially Optical or Optoelectronic Component, and Method for the Production Thereof

(75) Inventor: Klaus Hoehn, Forchheim (DE)

(73) Assignee: OSRAM Opto Semiconductors GmbH, Regensburg (DE)

(21) Appl. No.: 13/499,632

(22) PCT Filed: Sep. 20, 2010
(86) PCT No.: PCT/EP2010/063813

§ 371 Date: May 30, 2012

(30) Foreign Application Priority Data
Sep. 30, 2009 (DE) 102009047877.9
Nov. 25, 2009 (DE) 102009055765.2

(51) Int. Cl. H01B 1/22; B82Y 30/00

(52) U.S. Cl. 252/512; 977/773; 977/932; 977/810

(57) ABSTRACT

Electronic, in particular optical or optoelectronic, component comprising a device which comprises a thermoplastic material which has particles which comprise a core and a shell, wherein the shell is disposed on the surface of the core and wherein the core comprises aluminium.

Electronic, in particular optical or optoelectronic, component and method for the production thereof

This patent application claims the priority of German patent application 10 2009 047 877.9 and German patent application 10 2009 055 765.2, the disclosure content of which is hereby incorporated by reference.

An electronic, in particular optical or optoelectronic, component is provided in accordance with claim 1.

A very widespread problem of optical or optoelectronic components is that ever brighter radiation sources having higher operating temperatures and shorter wavelengths are used, and as a result the housing can be damaged by e.g. yellowing and chalking phenomena. As a consequence, e.g. the reflector can be damaged and therefore important optical properties such as the operating duration of the component or even the light yield can be significantly downgraded and the characteristic of the light emission can be changed.

An object of embodiments of the invention is to provide an electronic component which has an improved yellowing behaviour.

The object is achieved by an electronic component in accordance with claim 1. Further embodiments are described in further dependent claims.

One embodiment of the invention relates to an electronic, in particular optical or optoelectronic, component comprising a device which comprises a thermoplastic material which has particles which comprise a core and a shell, wherein the shell is disposed on the surface of the core and wherein the core comprises aluminium. The device can also consist of the thermoplastic material which has the particles. The core can comprise, or consist of, elemental aluminium.

By reason of their thermomechanical properties thermoplastic materials have good media resistance and adequate temperature and dimensional stability. They also have good fracture strength and crack resistance when the devices are subjected to cyclic and soldering bath loads. By reason of the low costs, it is also possible to produce large quantities of components in a cost-effective manner.

Aluminium particles have the following advantageous properties: they are non-toxic, available on the market at a favourable price, corrosion-resistant and media-resistant. They have a high thermal conductivity of about 220 W/mK. If they have a shell (e.g. an oxide layer on the surface) then they have at the same time good electrically insulating properties by reason of this shell. The good metallic reflectivity and the simultaneously high absorptivity in a broad wavelength range (UV to IR) render it possible primarily to use the particles in devices for optical or optoelectronic components.

In this application, the invention is described as being representative of electronic components with particular attention to optical or optoelectronic components. The embodiments relating to the optical or optoelectronic components also apply accordingly to electronic components.

A device which comprises such a thermoplastic material which has these particles with a core and shell has improved adhesion to e.g. metallic leadframes. This prevents the penetration of moisture or other harmful substances into the boundary surface of the device and leadframe which is susceptible to stress. By virtue of the increased barrier effect which is provided by the addition of the particles in the thermoplastic material, moisture absorption of the device and the diffusion of harmful gases by the device are also reduced.

By reason of the improved thermal conductivity of the device, the heat losses which occur during operation of the component can also be discharged more efficiently, whereby the ageing of the device in the housing material is reduced. As a consequence, the operating temperature of the component can also be increased. Furthermore, the component can be processed at higher temperatures.

In a further embodiment, the shell is disposed directly on the surface of the core.

Therefore, the core which comprises aluminium is surrounded directly by the shell. In one embodiment, the shell is fixedly connected to the surface of the core. Preferably, the shell is inseparably connected to the surface, e.g. if the shell develops or is produced as a result of a chemical reaction, in particular a solid state reaction, such as e.g. the formation of an oxide layer. Therefore, the material, of which the shell consists, is preferably a solid material.

In a further embodiment of the invention, the shell comprises an oxide, a nitride or an oxynitride.

Shells of these materials have a good electrically insulating property in combination with good thermal conductivity. They are also non-toxic and are significantly more corrosion-resistant and media-resistant compared with a metal. Preferably, the shell likewise comprises aluminium, e.g. as AlOₓ, AlNₓ, AlOₓN_{y}.

In a further embodiment of the invention, the shell has a thickness of greater than 10 nm.

A shell of this thickness serves to ensure an adequate electrically insulating property, as well as adequate corrosion protection for the core of the particles.

In a further embodiment of the invention, the shell has a thickness of less than 100 μm.

A shell thickness below 100 μm already has the above-described advantageous properties. A thickness of <100 μm renders it possible to minimise the particle size per se, which inter alia is important for the optical properties of the device. The thickness of the shell is preferably in a range of 50 nm to 25 μm.

For the purpose of directed reflection of radiation, particles having a smooth surface are preferably used, whereas for the purpose of a diffuse reflection particles having a rough surface are preferably used.

In a further embodiment of the invention, the shell electrically insulates the core.

This renders it possible to manufacture the core from an electrically conductive material and still use the particles in a range where the particles as a whole must be electrically insulating with respect to the area surrounding them. Therefore, this also permits the use of the particles in a thermoplastic material which can be used for a device which is used for an optoelectronic component. Therefore, the device can also be e.g. a cast device which is disposed on electrically conductive devices, which are not insulated towards the outside, of an optoelectronic component, such as e.g. contact elements. By virtue of the fact that the particles have electrically insulating properties, the entire thermoplastic material thus preferably has electrically insulating properties, thus preventing the risk of a short-circuit via the housing material which is manufactured from the thermoplastic material.

In a further embodiment of the invention, the shell at least partially comprises a coating on its surface.

The coating can be e.g. a coating of grinding aids. In one embodiment, a coating is provided which comprises a grinding aid. The grinding aid can be e.g. an animal or vegetable lubricant, as well as organic phosphonic acids or phosphonic acid esters. The animal and vegetable lubricants can be e.g. palmitic acid, stearic acid or oleic acid and the salts thereof with Zn, Ca or Mg.

In this case, the type and concentration of the lubricants can be selected in such a manner that during introduction of the particles into the thermoplastic material and during the subsequent production of the device the particles are disposed on the surface of the device and to a lesser extent in the interior of the device and provide the desired reflective properties. In this case, the concentration of the lubricant can be e.g. in the range of 0.05 pbw to 3′pbw in relation to the particle, wherein the range of 0.05 pbw to 1 pbw is preferred (pbw=parts by weight).

On the other hand, the type and concentration of the lubricant can be selected in such a manner that the particles become enriched primarily in the interior of the device and thus above all provide good thermal conductivity.

If the particles are introduced into the device primarily to improve the thermal conductivity, then they preferably have a lower concentration of grinding additive in the coating. Furthermore, these particles preferably have a thin shell. During production, the particles thus become cold-welded at the contact points.

In a further embodiment of the invention, the particles have an average particle size, measured as the d₅₀ -value, of 10 nm to 50 μm.

Preferably, the particles have an average particle size, measured as the d₅₀-value, between 10 nm and 20 μm. For example, the reflectivity can be optimised by the size, shape and roughness of the particles. Equally, the visual impression of the device can be influenced by the size of the particles. The device can thus be afforded a metallic visual effect e.g. using large particles and a high concentration of particles. The average particle size can be determined in this case by means of dynamic light scattering.

In a further embodiment of the invention, the concentration of particles in relation to the thermoplastic material is 0.001 to 20% by weight, wherein the range of 0.001 to 5% by weight is preferred.

The concentration of particles in the thermoplastic material is preferably between 0.001 to 1% by weight. Owing to the type and concentration of particles in the thermoplastic material, it is possible to control the reflectivity of the device which comprises the thermoplastic material. For example, the surface of the device can thus be afforded a metallic character.

In a further embodiment of the invention, the concentration of particles in relation to the thermoplastic material is 10 to 75% by weight.

In this case, the electronic, in particular optical or optoelectronic, component can be e.g. a component having a cooling function. This preferably comprises multimodal particles in flake form. As a consequence, the highest possible filling material content can be achieved.

In a further embodiment of the invention, the concentration of particles in relation to the thermoplastic material is 0.001 to 10% by weight.

In this case, the optical or optoelectronic component can be e.g. a component having good reflective properties. This preferably comprises spherical particles having a smooth surface, if the reflection is to be directed. In contrast, if the reflection is to be diffuse, the component preferably comprises particles with an irregular, rough surface. In both cases, the particles become enriched on the surface.

In a further embodiment of the invention, the core has an aluminium content of at least 99 mol.%.

In one embodiment, the core has an aluminium content of 100 mol.%, which means that the core consists completely of aluminium and optionally of small amounts of typical impurities. Aluminium proves to be non-toxic and is available on the market at a relatively favourable price. In comparison with other metals, aluminium also has a low density which means that the particles are fairly light.

In a further embodiment of the invention, the particles have a spherical form, a weakly ellipsoidal form or a form similar to these forms. In the case of the weakly ellipsoidal form, there is a radius ratio of ≦1.5.

In a further embodiment of the invention, the particles are in the form of flakes or have a strongly ellipsoidal form. In the case of the strongly ellipsoidal form, there is a radius ratio of >1.5.

In a further embodiment of the invention, the particles are in the form of fibres.

In the event that the particles have are in the form of flakes, fibres or have a strongly ellipsoidal form, the particles preferably have an average particle size, measured as the d₅₀-value, of 0.1 μm to 200 μm. In this case, an average particle size of 1.0 μm to 50 μm is preferred and the range of 1.0 μm to 20 μm is particularly preferred.

In order to achieve the desired optical properties and the desired thermal conductivity, it is possible to use particles of one form and also a mixture of particles of different forms. The same also applies to the size of the particles. In this case, there can be a monomodal distribution, i.e., the particles are of a similar size, such as also a multimodal form, i.e., the particles are significantly different in terms of their size.

The form of the particles can control e.g. the reflectivity such that the reflection is directed or diffuse.

A diffuse reflection can improve the light-mixing of radiation of a different wavelength e.g. on the housing wall surfaces.

In the event that the particles are in the form of flakes, fibres or have a strongly ellipsoidal form, the concentration of the particles in relation to the thermoplastic material is preferably 0.1 to 40% by weight, wherein the range of 0.1 to 30% by weight is particularly preferred.

In a further embodiment of the invention, the core comprises, or consists of, an aluminium alloy.

The alloy can comprise e.g. Si and/or Mg. Preferably it comprises Si. Such alloy components stabilise the core of the particles. The concentration of the alloy component is preferably in percentage by weight in relation to the aluminium quantity used in the range of 10 ppm to 0.9% by weight.

In a further embodiment of the invention, the thermoplastic material additionally comprises one or several loading materials selected from: glass fibres, glass fabric, glass powder, white pigments such as TiO₂, CaCO₃, BaSO₄, Al₂O₃, SiO₂, ZrO₂, light-converging substances, dyers, additives such as wetting agents, stabilisers, inorganic and metallic nanoparticles such as ZnO, ZrO₂, Au, Ag, Ti, phosphor-organic flame retardants.

In a further embodiment of the invention, the thermoplastic material is a synthetic material selected from polyaryl ether, polyphenyl ether, polysulfones, polyaryleneethersulfones, polyaryletherketones, polyetherimides, polycarbonates, polyamide, fluorine-containing polymers such as polytetrafluorethylene, tetrafluoroethylene-perfluoropropylene copolymers, polyvinylidene fluoride, polyvinyl fluoride, LCP and mixtures of different thermoplastic materials. In this case, the polyphthalamides are preferred amongst the polyamides.

In this case, the polyamide can be additionally charged with glass fibres, glass fabrics, carbon blacks or white pigments.

In a further embodiment of the invention, the device is a housing.

This housing can be formed e.g. as a reflector. The housing can have a radiation source e.g. in its interior.

The electronic, in particular optical or optoelectronic, component can be used e.g. in any one of the following fields: automotive industry, cooling media with optical functions, light construction housings and frame material in photovoltaic installations, medicine or sanitation. The component can be e.g. a headlight, a light module, a signal installation or a large-area light design element or an element thereof. This type of usage is of interest particularly by reason of the low weight and the heat-dissipating properties of the thermoplastic material which comprises the particles.

The electronic, in particular optical or optoelectronic, component can also be used with an increased level of reliability for modules and systems, and can be used under more stringent operating conditions, or it can be used for new applications which have a broadened functional range, such as e.g. housings for SMD-capable LEDs.

The present invention also relates to the use of an above-described thermoplastic material for the production of a device for an electronic, in particular for an optical or optoelectronic, component.

The thermoplastic material described which comprises the particles can be used e.g. for housings and/or reflectors in headlights, light modules, signal installations and a large-area light design element. The low weight and the heat-dissipating effect of the thermoplastic material or of the device which comprises the thermoplastic material can be advantageous. For the same reason, the described thermoplastic material which comprises the particles is suitable as a frame material in photovoltaic applications.

The thermoplastic material described which comprises the particles can be used as a thermoplastically processable composite material. In so doing, design freedom is acquired, which means that it can be used e.g. for cost-effective cooling channels in electronic components, modules and systems.

In addition to the component itself, the present invention also relates to a method for the production of a device for an electronic, in particular for an optical or optoelectronic, component.

In one variant of the method for the production of a device for an electronic, in particular for an optical or optoelectronic, component the method includes the method steps of: providing a thermoplastic material as method step A), incorporating particles which comprise, or consist of, a core and a shell, wherein the shell is disposed on the surface of the core and wherein the core comprises aluminium, as method step B) and forming a device as method step C).

In this case, the advantages explained with regard to the component also apply in a analogous manner to the method.

In a further variant of the method, the particles from method step B) are produced in a preceding method which comprises the steps of:

melting aluminium as method step a), atomising the melt from method step a), so that cores are formed, as method step b).

In a further variant, this preceding method additionally comprises the step of:

grinding the cores from, method step b), as method step c).

In a further variant, this preceding method additionally comprises the step of: conditioning the cores, so that a shell is formed on the surface of the cores, as method step d). In this case, method step d) can be performed prior to or after method step c).

In this case, the shell can also be formed between the core and a coating disposed thereon. In this case, the coating can be partially removed by the conditioning.

An exemplified embodiment will be described in greater detail hereinafter. The aluminium which is e.g. highly pure aluminium having a content of >99 mol.% is melted at a temperature of ca. 700° C. in method step a). In subsequent method step b), the molten aluminium is atomised at high pressure with air or inert gas (nitrogen, Ar, He). The atomising system and the atomising parameters have an influence upon the size and form of the cores. This can even have an indirect influence upon e.g. the thickness of the subsequent shell. The cores are ground in subsequent method step c). The grinding can be e.g. wet grinding in hydrocarbons, solvent naphtha, petroleum ether or toluene. This can be performed e.g. at a temperature of up to 70° C. The grinding can be performed e.g. using spherical grinding bodies of a defined size and quantity. During the grinding step, grinding aids such as e.g. waxes, oleic acid, stearic acid or palmitic acid can be added. In this case, the particle form depends to a very significant extent upon the grinding energy introduced and the hardness of the grinding bodies.

In a further variant, the grinding aids are completely or partially removed with organic solvents by washing.

In a further variant, the particle size and particle distribution are optimised by screening processes.

The conditioning of the cores in method step d) can be performed e.g. in a furnace at a temperature of 400° C. The conditioning can be performed over a period of e.g. 1 to 12 hours. The atmosphere used in this case can be e.g. air, oxygen, nitrogen or argon. Further surface modifications such as e.g. passivations can also be performed in plasma (oxygen, air, argon and mixtures thereof). In this case, the plasma power and the duration of the plasma treatment can be adjusted accordingly to the desired objectives. The particles which are thus obtained are stable with respect to moisture and are also hydrolysis-stable over the entire pH value range.

In a further variant of the method, the particles are dried prior to method step B) and after method step d) in a method step e). Drying can be effected e.g. over a period of 1 to 2 hours at a temperature of 120° C. In this case, a vacuum (<13 mbar) can also be applied at the same time.

In a further variant of the method, the processing of the thermoplastic material comprises the method steps of: preparing, drying, homogenising the raw materials and shaping. Each of the steps can be performed independently of each other in an atmosphere which comprises air or inert gas. In this case, the inert gas atmosphere can comprise nitrogen, argon or helium and is e.g. expedient if the formation of a shell, which comprises ALOₓ is not desired in this method step.

The method can comprise additional wet-chemical or dry-chemical-physical processes.

The above-described thermoplastic material can be used e.g. for cooling purposes in optical or optoelectronic components. For instance, the thermoplastic material can be used e.g. for SMD-components which can be used e.g. in the automotive industry.

The above-described thermoplastic material can also be used for minimising corrosion in e.g. leadframes. They can be e.g. leadframes which are silver-coated. They can be cast e.g. with silicone or silicone hybrids. Thermoplastic materials which comprise particles which have a shell of <5 μm, preferably <1 μm, are particularly suitable for this purpose. They can act as sources of aluminium which can emit Al³⁺ ions.

Variants of the invention will be described in detail hereinafter with reference to Figures and exemplified embodiments.

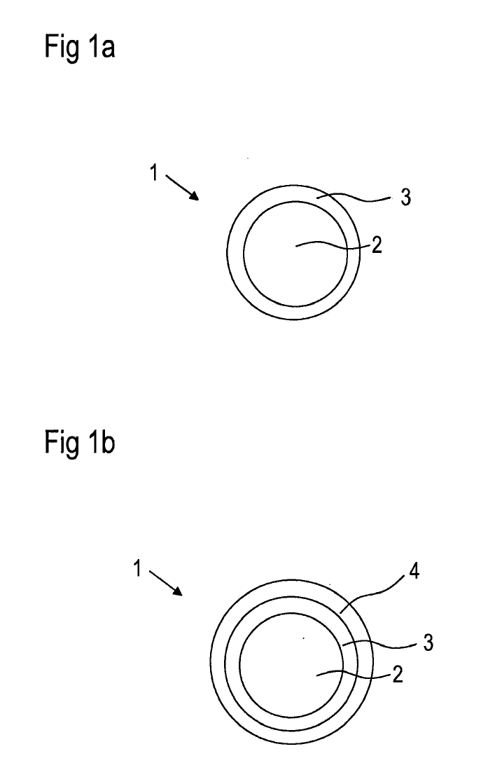

FIGS. 1a and 1b each show a schematic cross-section of one embodiment of a particle.

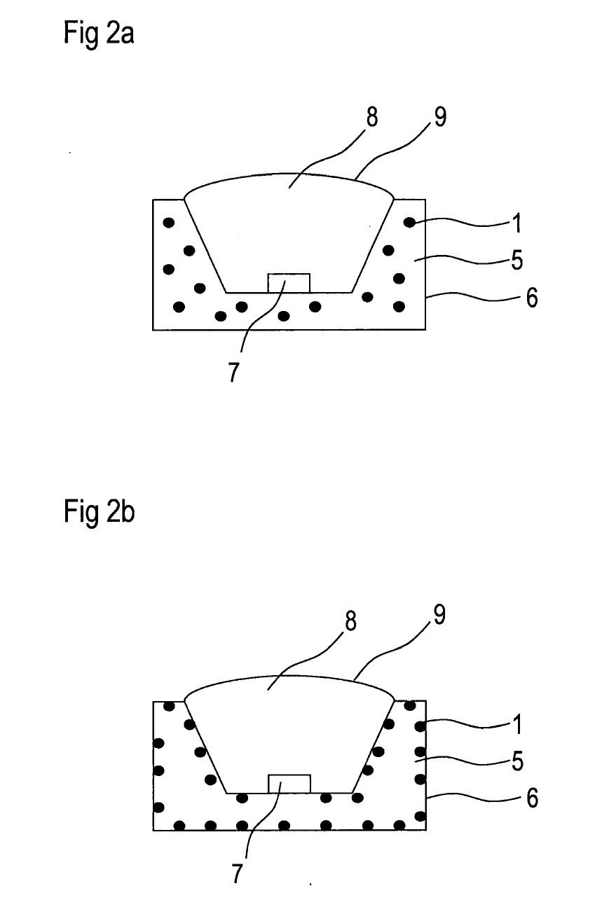

FIGS. 2a and 2b each show a schematic cross-section of an embodiment of an optoelectronic component.

FIG. 1a shows a schematic cross-section of a particle 1. The particle consists of a core 2 and a shell 3 which is disposed directly on the surface of the core 2.

FIG. 1b shows a schematic cross-section of a further embodiment of the particle 1. In comparison with the particle illustrated in FIG. 1a, this particle additionally comprises a coating 4 which is disposed directly on the surface of the shell 3.

FIG. 2a shows a schematic cross-section of one embodiment of an optoelectronic component. This component comprises a device 6 which is manufactured from a thermoplastic material 5. The thermoplastic material 5 comprises particles 1. In this exemplified embodiment, the device 6 is formed as a reflector. Disposed in the interior of the reflector trough is a radiation source 7. The radiation source 7 can be e.g. an inorganic LED or an organic LED (OLED). The radiation source 7 is cast with a casting compound 8 which forms a lens 9 on the radiation exit surface. The radiation emitted by the radiation source 7 can be reflected by the reflector, thus increasing the light yield of the optoelectronic component. The heat which develops during operation of the radiation source can be dissipated to the surrounding area via the device 6. In this case, the thermal conductivity is significantly increased by the particles 1 which are introduced into the thermoplastic material 5. This embodiment is e.g. very suitable for cooling the device. The particles preferably have a large surface, as is the case in flake form.

The LED comprises a semiconductor which forms a diode. LEDs are often so-called III/V-semiconductors, i.e., they are constructed from elements of the 3rd and 5th group of the periodic table. Furthermore, the LED comprises an anode which is located e.g. on the upper side of the LED, and a cathode which can be disposed accordingly on the underside. The anode can be connected in an electrically conductive manner via a bond wire to the leadframe, on which the LED can be disposed. If a voltage is applied in the forward direction, electrons migrate to the recombination layer at the p-n transition. On the n-doped side, the electrons populate the conduction band in order to change to the p-doped valency band, which in energy terms is more favourable, once the boundary surface has been passed. At this location, the electrodes then recombine with the holes present in this case.

An OLED comprises a layer stack comprising an anode and a cathode, from which by the application of a voltage holes or electrodes are emitted which travel in the direction of the respective other electrode. The charge carriers travel in this case e.g. initially through hole- or electron-transporting layers, before they impinge upon one another in a light-emitting layer. In this layer, the electrons together with the holes form excitons. The excitons can excite luminescent substances which are located in the emitting layer, for the emission of radiation. The OLED can comprise an organic functional layer which can be e.g. a light-emitting, charge carrier-blocking or charge carrier-transporting layer or a combination thereof.

FIG. 2b shows a schematic cross-section of a further embodiment of an optoelectronic component. This component, just like the embodiment illustrated in FIG. 2a, comprises a device 6 which is manufactured from a thermoplastic material 5. The thermoplastic material 5 comprises particles 1. In this case, the device 6 is also formed as a reflector. Disposed in the interior of the reflector trough is a radiation source 7. The radiation source 7 can likewise be e.g. an -inorganic LED or an organic LED (OLED). The radiation source 7 is cast with a casting compound 8 which forms a lens 9 on the radiation exit side. In contrast to the embodiment which is illustrated in FIG. 2a, the particles 1 in this embodiment are disposed on the surface of the device 6. The surface thus has a particularly high reflectivity. The thermoplastic material comprises preferably spherical particles having a smooth surface, if the reflection is to be directed. In contrast, if the reflection is to be diffuse, the thermoplastic material preferably has particles having an irregular rough surface.

The invention is not limited by the description using the exemplified embodiments. On the contrary, the invention includes any new feature and any combination of features included in particular any combination of features in the claims, even if this feature or this combination itself is not explicitly stated in the claims or exemplified embodiments.

1. An electronic, in particular optical or optoelectronic, component comprising a device which comprises a thermoplastic material which has particles which comprise a core and a shell, wherein the shell is disposed on the surface of the core and wherein the core comprises aluminium.

2. The component according to claim 1, wherein the shell is disposed directly on the surface of the core.

3. The component according to claim 1, wherein the shell comprises an oxide, a nitride or an oxynitride.

4. The component according to claim 1, wherein the shell has a thickness of greater than 10 nm.

5. The component according to claim 1, wherein the shell has a thickness of less than 100 μm.

6. The component according to claim 1, wherein the shell electrically insulates the core .

7. The component according to claim 1, wherein the shell comprises a coating on its surface.

8. The component according to claim 1, wherein the particles have an average particle size, measured as the d50-value, of 10 nm to 50 μm.

9. The component according to claim 1, wherein the concentration of particles in relation to the thermoplastic material is between 0.001 and 5% by weight.

10. The component according to one claim 1, wherein the core has an aluminium content of at least 99 mol.%.

11. The component according to claim 1, wherein the core comprises an aluminium alloy.

12. The component according to claim 1, wherein the device is a housing.

13. A method for the production of a device for an electronic, in particular for an optical or optoelectronic, component, comprising
A) providing a thermoplastic material;
B) incorporating particles which comprise a core and a shell, wherein the shell is disposed on the surface of the core and wherein the core comprises aluminium; and:
C) forming a device.

14. The method according to claim 13, wherein the particles from method step B) are produced in a preceding method which comprises the steps of:
a) melting aluminium,
b) atomising the melt from method step a), so that cores are formed,
c) grinding the cores from method step b), and
d) conditioning the cores from method step c), so that a shell is formed on the surface of the cores.

15. The method according to claim 14, wherein the particles are dried prior to method step B) and after method step d) in a method step e).

16. . An optoelectronic component comprising a device which comprises a thermoplastic material which has particles which comprise a core and a shell, wherein the shell is disposed on the surface of the core and wherein the core comprises aluminium.

17. An electronic, in particular optical or optoelectronic, component comprising a device which comprises a thermoplastic material which has particles which comprise a core and a shell, wherein the shell is disposed on the surface of the core and wherein the core comprises aluminium, wherein the shell comprises a coating on its surface, wherein the coating comprises a lubricant, wherein the type and concentration of the lubricant can be selected in such a manner that the particles are disposed on the surface of the device and to a lesser extent in the interior of the device or the type and concentration of the lubricant can be selected in such a manner that the particles become enriched primarily in the interior of the device.
